(19) United States
(12) Patent Application Publication
(10) Pub. No.: US 2002/0186247 A1
(43) Pub. Date: Dec. 12, 2002

(54) Method of displaying delay

(75) Inventor: Norio Ohkubo, Tokyo (JP)

Correspondence Address: Miles & Stockbridge P.C., Suite 500, 1751 Pinnacle Drive, McLean, VA, 22102-3833, US

(73) Assignee: Hitachi, Ltd.

(21) Appl. No.: 10/162,066

(22) Filed: Jun. 5, 2002

(30) Foreign Application Priority Data
Jun. 11, 2001 (JP) 2001-174986

(51) Int. Cl. G09G 5/00

(52) U.S. Cl. 345/772

(57) ABSTRACT

There is provided a method of displaying calculated delay which can easily grasp the state of the entire logical block and acquire the detailed information on delay violation paths. A display screen has a first window displaying a path delay list of a combination of a source and a sink of a path and a second window displaying a cell delay list of cells corresponding to the route of the path. A path is selected on the first window to display the detail of the corresponding path on the second window. It is easily possible to grasp the state of the entire logical block and acquire the detailed information on delay violation paths. The design period of a semiconductor integrated circuit can be reduced largely.

### FIELD OF THE INVENTION

The present invention relates to a method of displaying calculated delay in designing a semiconductor integrated circuit. In particular, the present invention relates to a method of displaying calculated delay effective in application when using a computer to design a large-scale semiconductor integrated circuit.

### BACKGROUND OF THE INVENTION

With complication of semiconductor integrated circuits, it is becoming very difficult to design a semiconductor integrated circuit so as to satisfy aimed delay. To design a high-performance semiconductor integrated circuit, enormous path delay must be within aimed delay. A great number of processes are thus required. An automatic process using a computer can design path delay to some extent within aimed delay. However, all path delays cannot be actually within aimed delay at a time. A logic circuit designer must analyze calculated delay to eliminate delay violation paths. To efficiently eliminate delay violation paths, a method of displaying interactive calculated delay using graphical user interface (hereinafter, called GUI) is used.

As a prior art method of displaying calculated delay using GUI, there is a timing inspecting device disclosed in Japanese Published Unexamined Patent Application No. Hei 4-273581.

To eliminate delay violation paths, grasping of the state of the entire logical block and acquisition of the detailed information on delay violation paths must be performed frequently. The prior art method of displaying calculated delay does not consider this point sufficiently. Delay violation paths cannot be eliminated efficiently.

In addition, a logic circuit designer must find abnormal locations of delay violation paths. The prior art method of displaying calculated delay does not consider this point sufficiently. Delay violation paths cannot be eliminated efficiently.

Further, in the case that the number of delay violation paths is enormous, the logic circuit designer must analyze all the paths. The prior art method of displaying calculated delay does not consider this point sufficiently. Delay violation paths cannot be eliminated efficiently.

### SUMMARY OF THE INVENTION

A first object of the present invention is to provide a method of displaying calculated delay which can easily grasp the state of the entire logical block and acquire the detailed information on delay violation paths and can efficiently eliminate delay violation paths.

A second object of the present invention is to provide a method of displaying calculated delay which can easily find abnormal locations of delay violation paths and can efficiently eliminate delay violation paths.

A third object of the present invention is to provide a method of displaying calculated delay which can reduce the number of paths to be analyzed by a logic circuit designer and can efficiently eliminate delay violation paths.

When displaying calculated delay, there are provided a first window displaying a path delay list in a combination of a source and a sink of a path and a second window displaying a delay list of cells included in the route of the path. A path is selected on the first window to display the detail of the corresponding path on the second window.

In addition, the cell delay list displayed on the second window is displayed by decomposing cell delay into intrinsic delay influenced by input-transition time, transition delay influenced by load capacitance, and interconnect delay influenced by wire. When these are judged to be an abnormal value, these are highlighted to be identified from others. This can easily find abnormal locations of delay violation paths to efficiently eliminate delay violation paths.

Further, in the path delay list displayed on the first window, in a plurality of paths sharing the number of cell stages in any specified proportion of the number of all cell stages of the route of a path, only one path having the longest delay is displayed, one path having the longest delay is highlighted, or the display color of paths other than one path having the longest delay is faded. This can reduce the number of paths to be analyzed by the logic circuit designer and can efficiently eliminate delay violation paths.

The foregoing objects and other objects of the present invention will be apparent by the following detailed description and the attached claims with reference to the accompanying drawings. In the accompanying drawings, the same reference numerals denote identical or similar parts.

### BRIEF DESCRIPTION OF THE DRAWINGS

FIG. 1 is a diagram showing a display screen of a method of displaying calculated delay of the present invention;

FIG. 2 is a diagram showing another display screen of the method of displaying calculated delay of the present invention;

FIG. 3 is a diagram showing another cell delay list display screen of the method of displaying calculated delay of the present invention;

FIG. 4 is a diagram showing a further cell delay list display screen of the method of displaying calculated delay of the present invention;

FIG. 5 is a diagram showing a further display screen of the method of displaying calculated delay of the present invention;

FIG. 6 is a diagram showing a still another display screen of the method of displaying calculated delay of the present invention;

FIG. 7 is a logic diagram of assistance in explaining a method of compressing the number of paths;

FIG. 8 is a diagram showing a process procedure of the method of compressing the number of paths;

FIG. 9 is a diagram showing another process procedure of the method of compressing the number of paths; and

FIG. 10 is a logic diagram of assistance in explaining the method of displaying calculated delay of the present invention.

### DETAILED DESCRIPTION OF THE PREFERRED EMBODIMENTS

Embodiments of the present invention will be described with reference to the drawings.

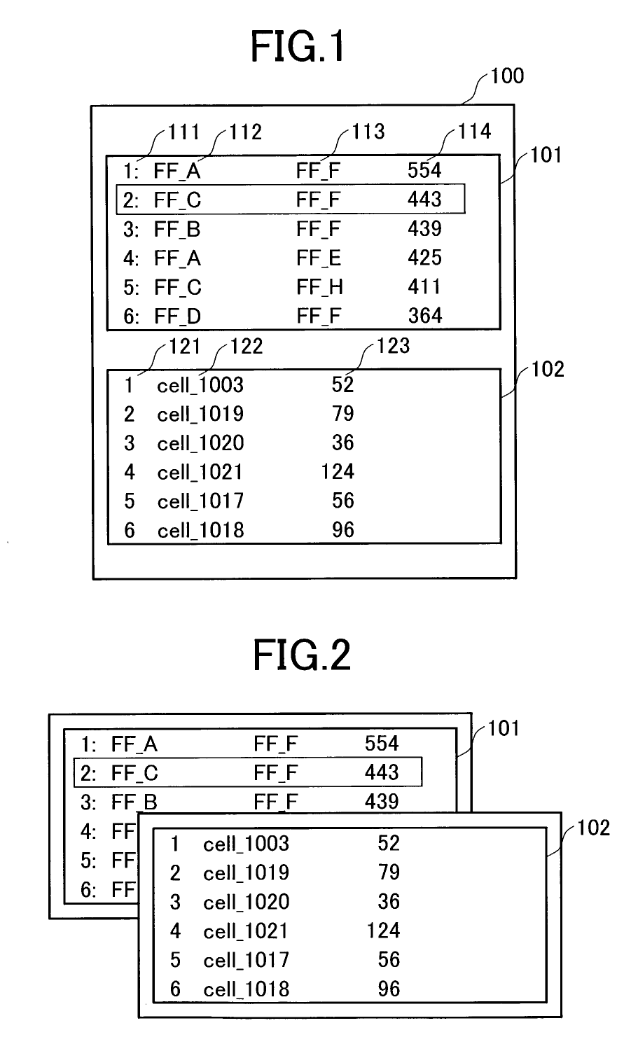

FIG. 1 is a display screen example of assistance in explaining a method of displaying calculated delay of the present invention. A main window 100 includes a first window 101 and a second window 102. The first window 101 displays a delay list (hereinafter, referred to as a path delay list) of paths (defined by a combination of a source and a sink) included in a circuit block to be designed. The second window 102 displays a delay list (hereinafter, referred to as a cell delay list) of cells included in a certain path displayed in the path delay list. Here, the cell refers to an element circuit constructing a semiconductor integrated circuit.

The path delay list has a path number 111 for specifying a path, a source flip flop name 112, a sink flip flop name 113, and a path delay 114. The cell delay list has a cell number 121 specifying cells through which a path passes, a cell name 122, and a cell delay 123.

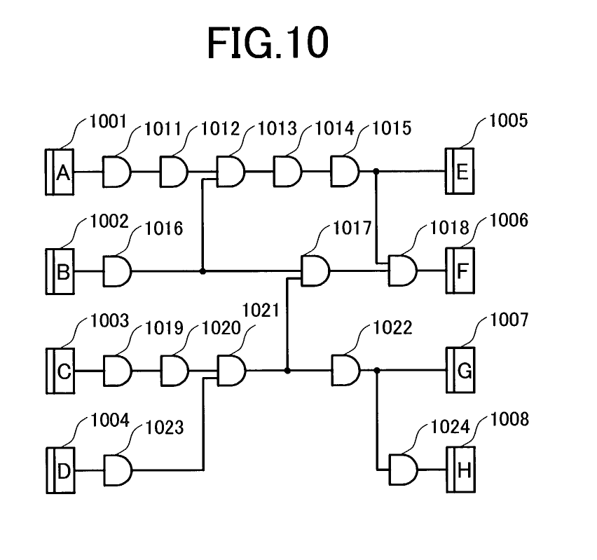

The present invention will be described in detail using an example of a logic circuit shown in FIG. 10. A computer is used to calculate delays of all paths and the calculated path delays are stored in a storage unit of the computer. Here, all paths refer to all paths existing with flip flops A, B, C and D as sources and flip flops E, F, G and H as sinks. Specifically, there exist 10 paths including A to E, A to F, B to E, B to F, C to F, C to G, C to H, D to F, D to G, and D to H. The window 101 displays the upper 6 paths in decreasing order of path delay. In FIG. 1, a path 2 is selected and the window 102 displays cells through which the path 2 passes. In other words, the path 2 is a route passing through cells 1003, 1019, 1020, 1021, 1017 and 1018. A cell delay 123 is displayed for each of the cells. The total value of the cell delays 123 of all cells through which the path passes corresponds to the path delay 114.

A path is selected on the first window 101 displaying the path delay list to display the cell delay list of cells through which the path passes on the second window 102. As a path selecting method, it is possible to use known methods such as a method of clicking a displayed path using a mouse cursor and a method of selecting a path with an enter key by moving a cursor up and down from an arrow key using a key board.

According to the example shown in FIG. 1, a logic circuit designer can grasp the state of the entire circuit block on the first window 101 displaying the path delay list. The detailed information on a path can be checked by the cell delay list displayed on the second window 102 so as to efficiently eliminate delay violation paths. For example, it is found that many paths having long delay with FF_F as a sink exist on the first window 101. Delay violation path elimination may be thus performed around FF_F.

The detail of the path is checked on the second window 102 to study a specific eliminating method. Elimination of one delay violation path may influence a great number of path delays. In this case, the influence of the elimination must be studied in a wide range. Using the displaying method shown in FIG. 1, other path delays can be seen instantly. The period to eliminate the delay violation paths can be shortened.

In the example shown in FIG. 1, the flip flop name is displayed for the source and the sink of the path delay list. A signal name connected to the flip flop may be displayed.

FIG. 2 is another display screen example of assistance in explaining the method of displaying calculated delay of the present invention. The first window 101 displaying the path delay list is a main window. A path is selected on the first window 101 to newly open the second window 102 displaying the cell delay list of cells through which the path passes, thereby displaying the detail of the corresponding path on the second window 102. The detail of a plurality of paths can be seen at the same time. When studying the plurality of paths at the same time, delay violation paths can be eliminated efficiently.

A method of displaying the cell delay list will be described.

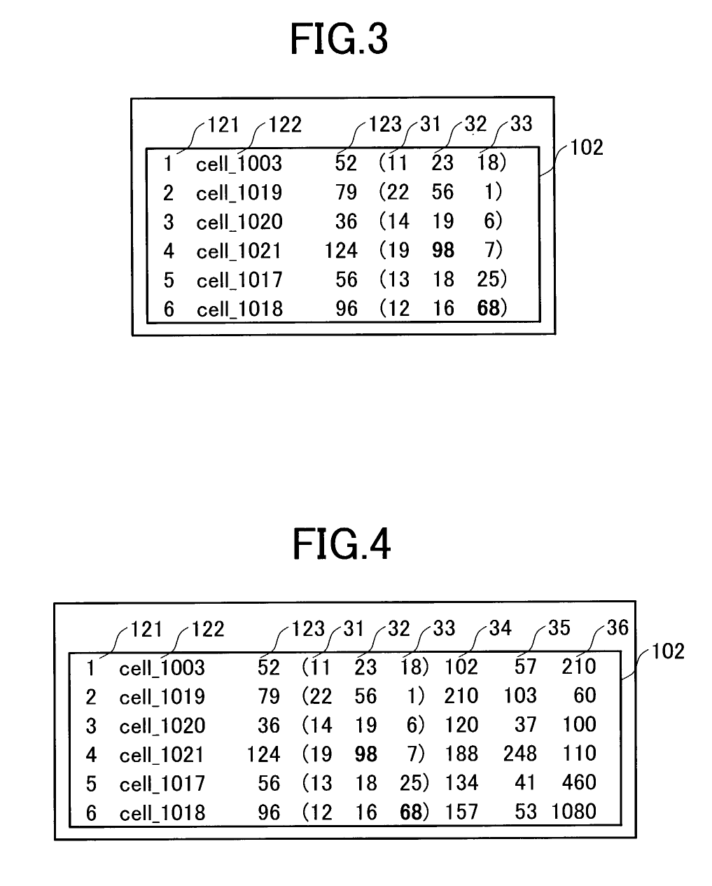

FIG. 3 is another display screen example of the second window 102 displaying the cell delay list of cells through which a path passes. A value of each of the cell delays 123 is decomposed into intrinsic delay 31 influenced by input-transition time, transition delay 32 influenced by load capacitance, and interconnect delay 33 influenced by wire for display. The intrinsic delay 31, the transition delay 32 and the interconnect delay 33 can be easily obtained by a delay calculating process. The intrinsic delay 31 can be obtained as cell delay when a load capacitance is 0. The transition delay 32 can be obtained as delay obtained by subtracting the intrinsic de lay 31 from cell delay calculated from an actual load. The interconnect delay 33 can be obtained as delay of a wire part.

The delay is decomposed into the intrinsic delay 31, the transition delay 32 and the interconnect delay 33. The cause of long cell delay can be easily analyzed. Delay violation paths can be eliminated efficiently. For example, when the intrinsic delay 31 is long, the input-transition time is considered to be long. The drive power of the previous stage may be increased. When the transition delay 32 is long, the load capacitance is considered to be large. The load may be reduced or the previous stage cell may be replaced with a cell having a high drive power. When the interconnect delay 33 is long, the cell arrangement may be changed to shorten the wire length or a wire permitting high-speed transfer may be used.

About whether these values are large or not, a standard value is determined previously, and these values exceeding the value are highlighted to be identified from others by font, character decoration or display color. Abnormal locations can be easily found. In the display screen example of FIG. 3, the values exceeding 60 are displayed in boldface type. That the transition delay 32 of cell_1021 of the fourth cell and the interconnect delay 33 of cell_1018 of the sixth cell are long is clear at a glance. Delay violation paths can be eliminated more efficiently.

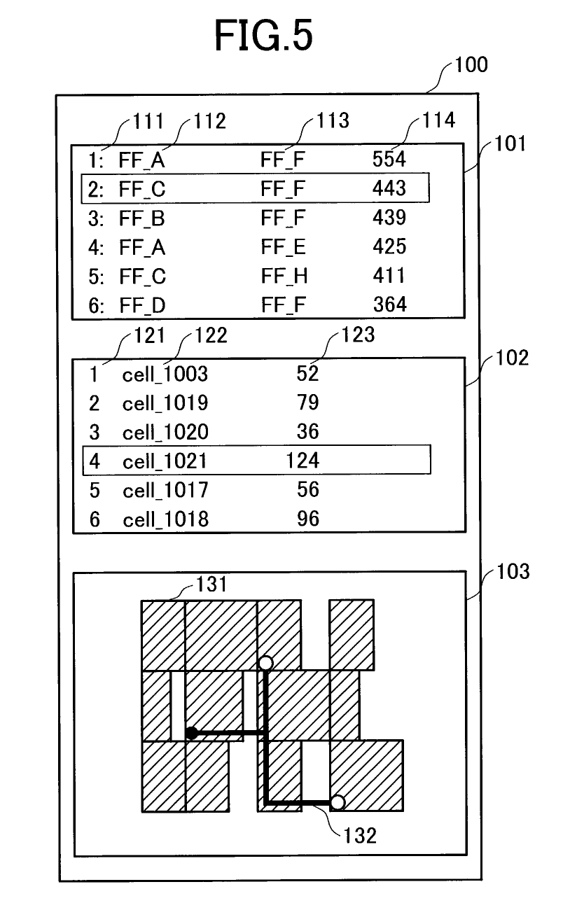

FIG. 4 is a further display screen example of the second window 102 displaying the cell delay list of cells through which a path passes. In addition to the contents displayed in the screen example of FIG. 3, this display screen displays input-transition time 34, a load capacitance 35 and a wire length 36 causing cell delay. The input-transition time 34, the load transition 35 and the wire length 36 are values used in the delay calculating process. The cause of long cell delay can be thus easily analyzed. Delay violation paths can be eliminated efficiently. For example, when the intrinsic delay 31 is long and the value of the input-transition time 34 is large, the previous stage cell may be replaced with a cell having a high drive power or the previous stage load may be reduced. When the transition delay 32 is long and the load capacitance 35 is large, the load may be reduced or the previous stage cell may be replaced with a cell having a high drive power. When the interconnect delay 33 is long and the wire length 36 is large, the cell arrangement may be changed to shorten the wire length or a wire permitting high-speed transfer may be used.

In the example shown in FIG. 4, the transition delay 32 of cell_1021 of the fourth cell is long. This can be assumed that the load capacitance 35 is large. In addition, the interconnect delay 33 of cell_1018 of the sixth cell is long. This can be assumed that the wire length 36 is large. This can study the respective eliminating methods.

A method of displaying calculated delay using layout display of a logic circuit will be described.

FIG. 5 is a further display screen example of assistance in explaining the method of displaying calculated delay of the present invention. This example has a third window 103 displaying a layout of logic circuits. A cell is selected on the second window 102 to display a connection state on the layout on the third window 103 displaying the layout of the logic circuits. In FIG. 5, the numeral 131 denotes a cell on the layout. The numeral 132 denotes a wire. The connection state on the layout is displayed. When cell delay is long, whether the layout is changed or not can be studied. Delay violation paths can be eliminated efficiently.

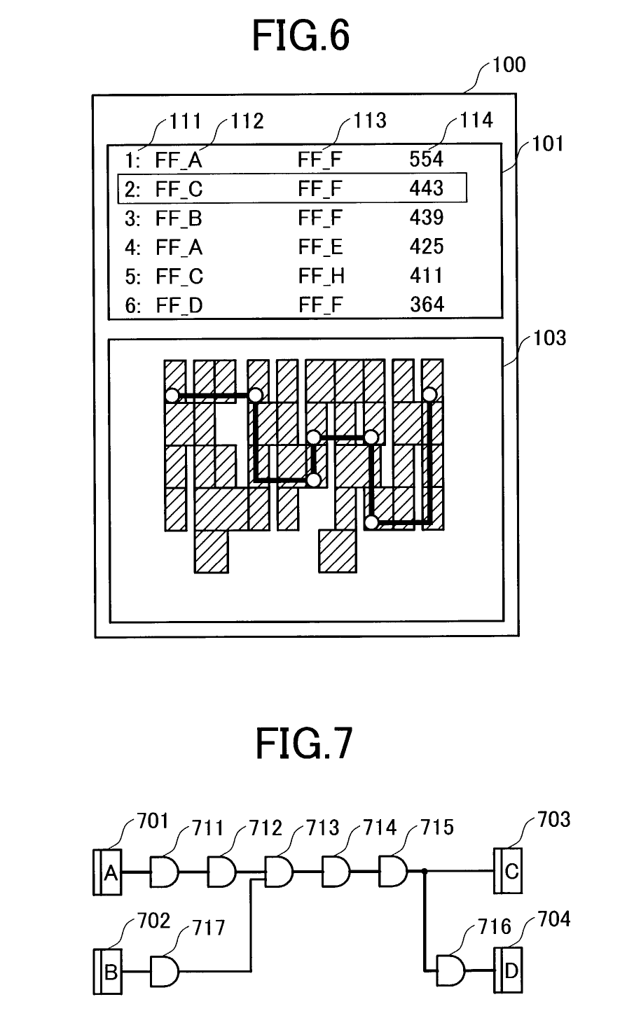

FIG. 6 is a still another display screen example of assistance in explaining the method of displaying calculated delay of the present invention. This example has the third window 103 displaying a layout of logic circuits. A path is selected on the first window 101 displaying the path delay list to display a path route on the layout on the third window 103 displaying the layout of the logic circuits. The path route on the layout is displayed. When path delay is long, whether the layout of the entire block is changed or not can be studied. Delay violation paths can be eliminated efficiently.

A method of reducing the number of displayed paths will be described.

When the number of delay violation paths is enormous, the logic circuit designer must analyze all paths. The number of processes for eliminating delay violation paths must be large. Some such delay violation paths may have a common route of part thereof with other delay violation paths. When the number of cell stages of such a common route makes up a constant proportion or more of the number of all cell stages, only one path having the longest delay of a plurality of delay violation paths having the common route is displayed on the first window. This can reduce the number of paths to be eliminated by the logic circuit designer. This is because in the paths sharing the number of cell stages in a constant proportion or more, one path is eliminated to remove other paths. The proportion is specified previously. The displaying method is not limited to the method of displaying only one path having the longest delay. One path having the longest delay may be highlighted, or the display color of a path other than the one path having the longest delay may be faded. The corresponding one path may be displayed to be identified.

FIG. 7 is a diagram of assistance in explaining a method of compressing the number of paths. In FIG. 7, there exist routes having flip flops A and B as a source and flip flips C and D as a sink, that is, four paths of A to C, A to D, B to C and B to D. These paths share cells 713, 714 and 715. Under displayed path conditions, only one path having the longest delay of the paths in a proportion of the number of common stages of 0.5 or more is displayed. In the case of the circuit shown in FIG. 7, the path having the flip flop A as a source, the cells 711, 712, 713, 714, 715 and 716 as a route and the flip flop D as a sink has the longest delay and the number of stages is 6. Other paths have three common stages and a proportion of 0.5 or more. Only the path having the flip flop A as a source and the flip flop D as a sink is displayed and other paths are not displayed.

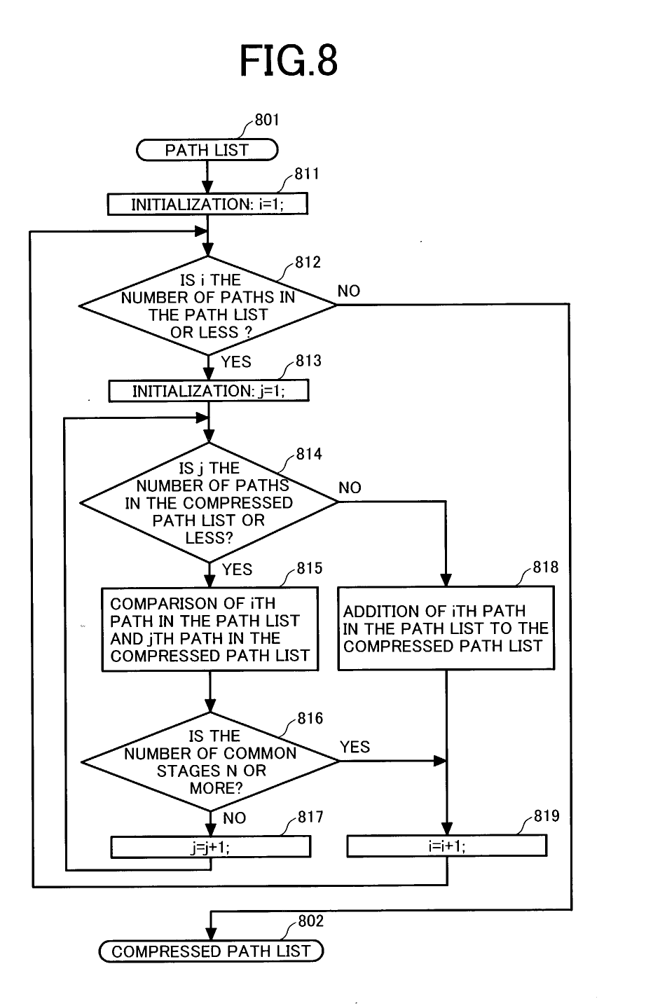

A method of compressing the number of paths will be described in detail using the path compressing process procedure shown in FIG. 8. In this process procedure, a path list 801 arranging path delays in decreasing order is inputted to obtain a compressed path list 802 reducing the number of paths. In the path list 801 of the logic circuits of FIG. 7, the first path is A to D, the second path is A to C, the third path is B to D and the fourth path is B to C. The process procedure will be described below. The initial value of the compressed path list 802 is empty. A process 811 initializes an internal parameter i to 1. A process 812 is condition decision whether the internal parameter i is the number of paths in the path list or less. In this case, the internal parameter i is 1 and the number of paths is 4. The routine is thus advanced to YES. A process 813 initializes an internal parameter j to 1. A process 814 is condition decision whether the internal parameter j is the number of paths in the compressed path list or less. In this case, the internal parameter j is 1 and the number of compressed paths is 0. The routine is thus advanced to NO. A process 818 adds the first path to the compressed path list. A process 819 increments the internal parameter i to return to the process 812. In the process 812, the internal parameter i is 2 and the number of paths is 4. The routine is thus advanced to YES. The process 813 initializes the internal parameter j to 1. The process 814 performs condition decision whether the internal parameter j is the number of paths in the compressed path list or less. In this case, the internal parameter j island the number of the compressed paths is 1. The routine is thus advanced to YES. A process 815 compares the second path in the path list with the first path in the compressed path list. From this process, it is found that the second path in the path list and the first path in the compressed path list have five common stages. A process 816 is condition decision whether the number of common stages is N or more. Here, N is the number of stages obtained by multiplying the number of stages of the jth path in the compressed path list by a specified proportion. In this case, N is 6*0.5=3 stages. The routine is thus advanced to YES to execute the process 819. The process 819 increments the internal parameter i to return to the process 812. The routine is repeated likewise until the internal parameter i exceeds 4 as the number of paths in the path list to obtain the compressed path 802.

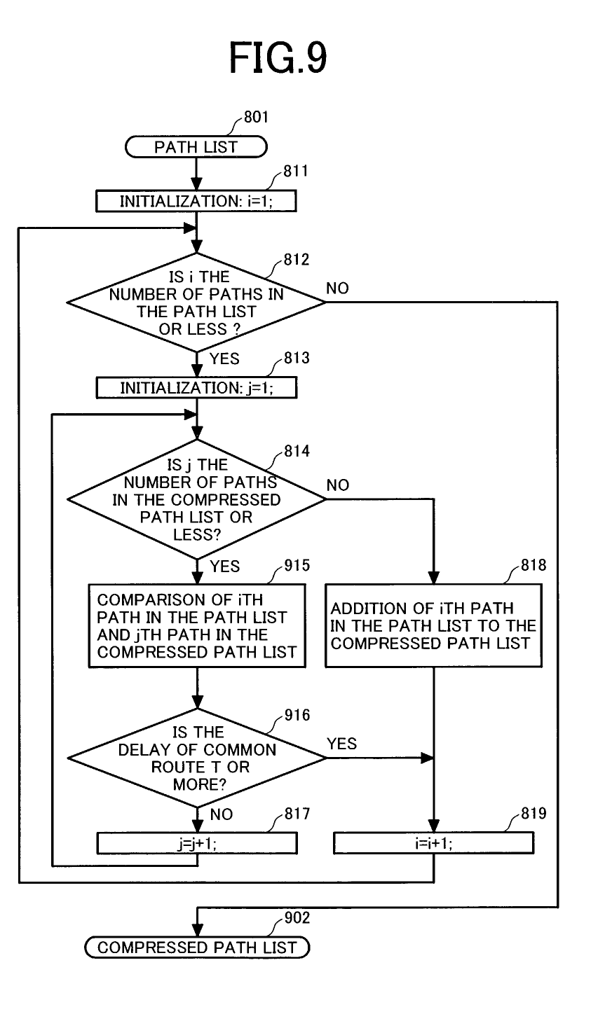

FIG. 9 shows another path compressing process procedure. In this process procedure, the path list 801 arranging path delays in decreasing order is inputted. Only one path having the longest delay of a plurality of paths having the delay of the common path in any specified proportion or more of all path delays is added to a compressed path list 902. The compressed path list 902 reducing the number of paths can be obtained. In the path list 801 of the logic circuits of FIG. 7, the first path is A to D, the second path is A to C, the third path is B to D, and the fourth path is B to C. The process procedure will be described below. The initial value of the compressed path list 902 is empty. The process 811 initializes an internal parameter i to 1. The process 812 is condition decision whether the internal parameter i is the number of paths in the path list or less. In this case, the internal parameter i is 1 and the number of paths is 4. The routine is thus advanced to YES. The process 813 initializes an internal parameter j to 1. The process 814 is condition decision whether the internal parameter j is the number of paths in the compressed path list or less. In this case, the internal parameter j is 1 and the number of the compressed paths is 0. The routine is thus advanced to NO. The process 818 adds the first path to the compressed path list. The process 819 increments the internal parameter i to return to the process 812. In the process 812, the internal parameter i is 2 and the number of paths is 4. The routine is thus advanced to YES. The process 813 initializes the internal parameter j to 1. The process 814 performs condition decision whether the internal parameter j is the number of paths in the compressed path list or less. In this case, the internal parameter j is 1 and the number of the compressed paths is 1. The routine is thus advanced to YES. A process 915 compares the second path in the path list with the first path in the compressed path list. From this process, delay of the common route of the second path in the path list and the first path in the compressed path list is obtained. In the logic circuits of FIG. 7, for example, in the case of comparing the path of A to D with the path of B to C, delay passing through the cells 713, 714 and 715 is obtained. A process 916 is condition decision whether the delay of the common route is T or more. Here, T is delay obtained by multiplying the delay of the jth path in the compressed path list by the specified proportion. In this case, the delay of the common route is assumed to be T or more. The routine is thus advanced to YES to execute the process 819. The process 819 increments the internal parameter i to return to the process 812. The routine is repeated likewise until the internal parameter i exceeds 4 as the number of paths in the path list to obtain the compressed path 902.

In the process procedure of FIG. 8, the number of paths is compressed by the number of common stages. In the process procedure of FIG. 9, the number of paths is compressed by the common delay. When delays per stage are largely different depending on the cell type, compression of the number of paths by the delay in the process procedure of FIG. 9 can correctly compress the number of paths.

The present invention can easily grasp the state of the entire logic block and acquire the detailed information on delay violation paths and can efficiently eliminate delay violation paths.

What is claimed is:

1. A method of displaying delay which displays delay of a plurality of paths included in a semiconductor integrated circuit using a computer having a display unit, comprising the steps of:
storing delay of said plurality of paths included in said semiconductor integrated circuit;
displaying delay of at least one of said plurality of paths on a first window on said display unit; and
upon reception of selection of the path displayed on said first window, displaying delay of cells included in the route of said selected path on a second window on said display unit.

2. The method of displaying delay according to claim 1, wherein said second window is displayed on said display unit after receiving the selection of the path displayed on said first window.

3. The method of displaying delay according to claim 1, wherein the delay of each of the cells included in the route of said selected path is decomposed into intrinsic delay influenced by input-transition time, transition delay influenced by load capacitance, and interconnect delay influenced by wire, which are displayed on said second window.

4. The method of displaying delay according to claim 1, wherein in addition to the delay of each of the cells included in the route of said selected path, at least any one of the input-transition time, the load capacitance and the wire length is displayed

5. The method of displaying delay according to claim 3, wherein said intrinsic delay, said transition delay and said interconnect delay which are predetermined delay or more are displayed to be identified from those less than said predetermined delay.

6. The method of displaying delay according to claim 1, wherein upon reception of the selection of the path displayed on said first window, a layout including the route of said selected path is displayed on a third window on said display unit.

7. The method of displaying delay according to claim 6, wherein upon reception of the selection of the cell displayed on said second window, a connection state on the layout is displayed on said third window.

8. The method of displaying delay according to claim 1, wherein:
said plurality of paths include a first path and a second path having delay longer than that of said first path and a proportion of the number of common cell stages of said first path and said second path in the number of all cell stages of said first path and a proportion of the number of said common cell stages in the number of all cell stages of said second path are a predetermined value or more; and
while the delay of said second path is displayed on said first window, the delay of said first path is not displayed on said first window, or the delay of said second path is displayed on said first window to be identified from the delay of said first path.

9. The method of displaying delay according to claim 1, wherein:
said plurality of paths include a first path and a second path having delay longer than that of said first path and a proportion of the delay of a common path of said first path and said second path in the delay of said first path and a proportion of the delay of said common path in the delay of said second path are a predetermined value or more; and
while the delay of said second path is displayed on said first window, the delay of said first path is not displayed on said first window, or the delay of said second path is displayed on said first window to be identified from the delay of said first path.
